(19) United States
(12) Patent Application Publication
(10) Pub. No.: US 2016/0227570 A1
(43) Pub. Date: Aug. 4, 2016

(54) BASE STATION AND UPLINK CONTROL INFORMATION SCHEDULING METHOD FOR CARRIER AGGREGATION COMMUNICATION SYSTEM

(71) Applicant: Institute For Information Industry, Taipei (TW)

(72) Inventors: Chia-Hung WEI, Taipei City (TW); Hai-Han WANG, Taipei City (TW); Feng-Ming YANG, Taipei City (TW)

(21) Appl. No.: 15/004,735

(22) Filed: Jan. 22, 2016

Related U.S. Application Data
(60) Provisional application No. 62/109,645, filed on Jan. 30, 2015.

(51) Int. Cl. H04W 72/12; H04L 5/00

(52) U.S. Cl. CPC H04W 72/1284; H04L 5/0057

(57) ABSTRACT

A base station and an uplink control information scheduling method for a carrier aggregation communication system which provides a user equipment with a plurality of component carriers are provided. The base station creates an uplink control information schedule for uplink control information generated by the user equipment and provides the user equipment with the uplink control information schedule so that the user equipment transmits the uplink control information on the component carriers according to the uplink control information schedule. The uplink control information scheduling method includes steps corresponding to the operations of the base station.

### PRIORITY

This application claims priority to U.S. Provisional Patent Application No. 62/109,645 filed on Jan. 30, 2015, which is incorporated herein by reference in its entirety.

### FIELD

The present invention relates to a base station and an uplink control information scheduling method. More particularly, the present invention relates to a base station and an uplink control information scheduling method for a carrier aggregation communication system.

### BACKGROUND

Improving the transmission speed is one of objectives pursued in wireless communication systems all the time, and the simplest way to improve the transmission speed is to increase the transmission bandwidth. Over recent years, some wireless communication systems have adopted a technology named Carrier Aggregation (CA) to increase the transmission bandwidth, thereby improving the transmission speed. For example, the Long Term Evolution Advanced (LTE-Advanced) proposed by the Third Generation Partnership Project (3GPP) has also adopted the CA technology.

Different from the single carrier technology, CA is a multiple carrier technology aggregating several component carriers (CC). A traditional CA communication system usually comprises one primary CC (PCC) and at least one secondary CC (SCC). Additionally, a single user equipment (UE) can transmit uplink data in data transmission channels respectively created on several component carriers (i.e., the PCC and the at least one SCC), but it can only transmit uplink control information (UCI) corresponding to all the component carriers in a control channel created on the PCC.

For example, when the LTE-Advanced (i.e., the 10^{th} release) is initially proposed by the 3GPP, the CA technology was planned to be capable of providing at most five component carriers (including one PCC and four SCCs) for a single user equipment, wherein the user equipment can transmit the uplink data in the data transmission channels (i.e., physical uplink shared channel (PUSCH)) respectively created on the at most five component carriers, and the user equipment has to transmit the uplink control information (UCI) corresponding to the five component carriers in the control channel (i.e., physical uplink control channel (PUCCH)) created on the PCC. Additionally, in the 13^{th} release proposed by the 3GPP, the CA technology was further planned to be capable of providing at most 32 component carriers (including one PCC and 31 SCCs) for a single user equipment, but the user equipment still must transmit the uplink control information corresponding to the 32 component carriers in the PUCCH created on the PCC according to the specifications regarding CA in the previous versions.

In the traditional CA communication system, the transmission speed increases as the number of the SCCs increases; however, the load of the control channel created on the PCC also increases as the number of the SCCs increases. Accordingly, an urgent need exists in the art to reduce the load of the control channel created on the PCC, which increases as the number of the SCCs increases, in the traditional CA communication system.

### SUMMARY

The disclosure includes a base station for a carrier aggregation communication system. The carrier aggregation communication system provides a user equipment with a plurality of component carriers. The base station comprises a processor and a transceiver connected with the processor. The processor is configured to create an uplink control information schedule for uplink control information generated by the user equipment. The transceiver is configured to provide the user equipment with the uplink control information schedule so that the user equipment transmits the uplink control information on the component carriers according to the uplink control information schedule. The uplink control information schedule divides the uplink control information into a plurality of information blocks according to information categories, and each of the information blocks comprises a plurality of information sub-blocks respectively corresponding to the component carriers. For each of the information blocks, the uplink control information schedule divides the component carriers into a plurality of carrier groups, each of the carrier groups comprises at least one uplink control channel, and the information sub-blocks corresponding to each of the carrier groups are scheduled to the at least one uplink control channel comprised in the carrier group.

The disclosure also includes an uplink control information scheduling method for a carrier aggregation communication system. The carrier aggregation communication system provides a user equipment with a plurality of component carriers. The uplink control information scheduling method comprises the following steps of: creating, by a base station, an uplink control information schedule for uplink control information generated by the user equipment, wherein the uplink control information schedule divides the uplink control information into a plurality of information blocks according to information categories, each of the information blocks comprises a plurality of information sub-blocks respectively corresponding to the component carriers, and for each of the information blocks, the uplink control information schedule divides the component carriers into a plurality of carrier groups, each of the carrier groups comprises at least one uplink control channel, and the information sub-blocks corresponding to each of the carrier groups are scheduled to the at least one uplink control channel comprised in the carrier group; and providing, by the base station, the user equipment with the uplink control information schedule so that the user equipment transmits the uplink control information on the component carriers according to the uplink control information schedule.

The disclosure further includes a user equipment that can transmit the uplink control information, via the uplink control information schedule created by a base station, in the plurality of uplink control channels created over the plurality of component carriers instead of only being capable of transmitting the uplink control information in a single uplink control channel created over a single component carrier (e.g., the aforesaid PCC). In this way, the load of the control channel created over the PCC can be distributed to control channels created over other component carriers according to the uplink control information schedule, so the load of the control channel created over the PCC is effectively reduced.

What described above presents a summary of some aspects of the present invention (including the problem to be solved, the means to solve the problem and the effect of the present invention) to provide a basic understanding of these aspects. However, this is not intended to contemplate all aspects of the present invention. Additionally, what described above is neither intended to identify key or essential elements of any or all aspects of the present invention, nor intended to describe the scope of any or all aspects of the present invention. This summary is provided only to present some concepts of some aspects of the present invention in a simple form and as an introduction to the following detailed description.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating an example of a carrier aggregation communication system according to one or more embodiments of the present invention;

FIG. 2 is a schematic view illustrating an example of a base station and a user equipment according to one or more embodiments of the present invention;

FIG. 3A to FIG. 3B are schematic views illustrating an example of an uplink control information schedule according to one or more embodiments of the present invention;

FIG. 4 is a schematic view illustrating an example of an overall operation of the carrier aggregation communication system shown in FIG. 1 according to one or more embodiments of the present invention; and

FIG. 5 is a flowchart diagram illustrating an example of an uplink control information schedule method for a carrier aggregation communication system according to one or more embodiments of the present invention.

### DETAILED DESCRIPTION

In the following description, details of the present invention will be further explained with reference to one or more example embodiments thereof. However, the one or more example embodiments described hereinafter are not intended to limit the present invention to any specific example, embodiments, environment, applications, structures, processes or steps described in these example embodiments. In the attached drawings, elements unrelated to the present invention are omitted from depiction; and dimensional relationships among individual elements in the attached drawings are illustrated only for ease of describing the present invention, but not to limit the actual scale. Unless otherwise specified, same (or similar) reference numerals correspond to the same (or similar) elements in the following description.

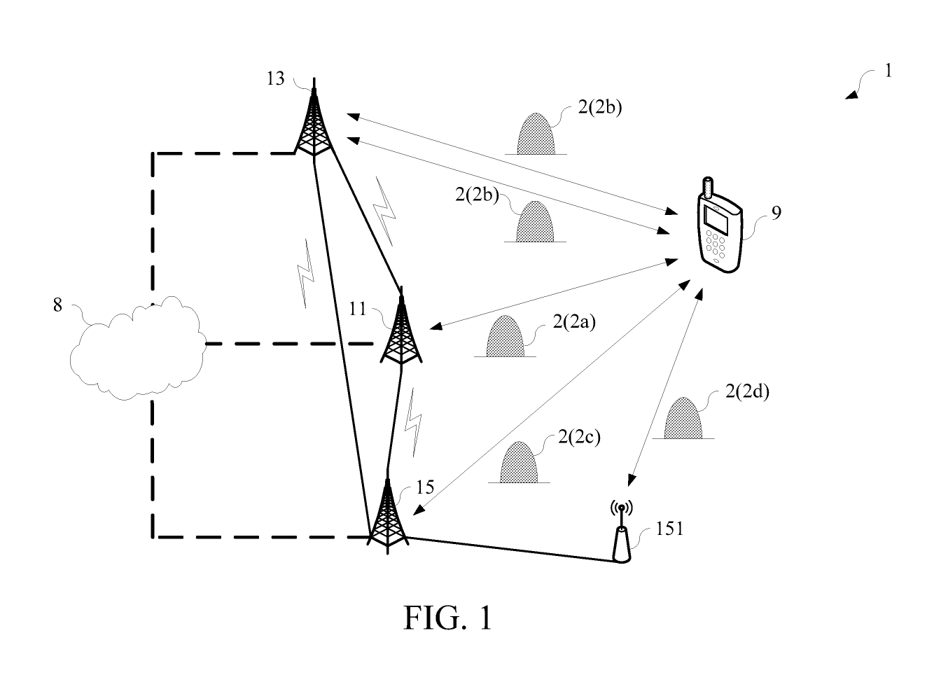

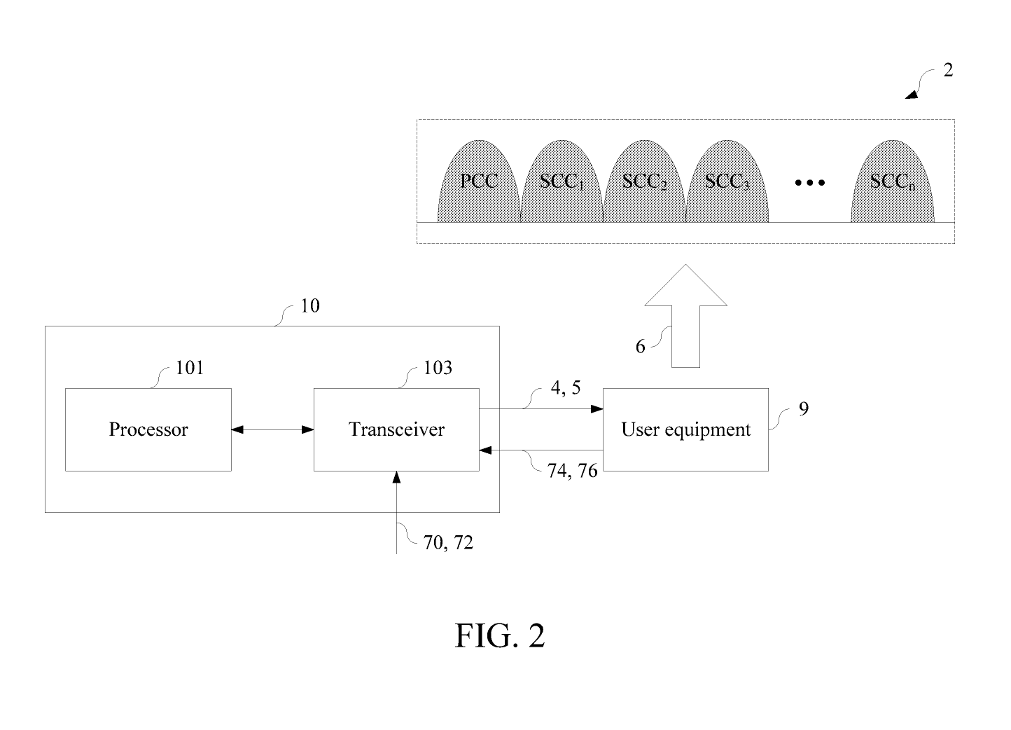

An embodiment of the present invention (which is called a “first embodiment” hereinafter) is a base station for a carrier aggregation (CA) communication system. The CA communication system may comprise at least one base station (i.e., one or more base stations) and at least one user equipment (i.e., one or more first user equipments). For ease of description, FIG. 1 and FIG. 2 are taken as an example herein to further describe the CA communication system and the base station; however, this example is not intended to be limiting. FIG. 1 is a schematic view illustrating an example of a carrier aggregation communication system according to one or more embodiments of the present invention. FIG. 2 is a schematic view illustrating an example of a base station and a user equipment according to one or more embodiments of the present invention.

Referring to FIG. 1, the CA communication system 1 may comprise a base station 11, a base station 13, a base station 15 and a user equipment 9. The CA communication system 1 may be constructed on various traditional wireless communication systems using carrier aggregation, such as (but not limited to) the LTE-advanced. Each of the base station 11, the base station 13 and the base station 15 may be any of various types of base stations, for example but not limited to: macrocells, microcells, picocells or the like. The user equipment 9 may be any of various types of electronic devices, such as (but not limited to) tablet computers, notebooks, intelligent mobile phones or the like.

The CA communication system 1 may provide the user equipment 9 with a plurality of component carriers 2. In detail, the base station 11 may provide the user equipment 9 with a single component carrier 2 (labeled as 2a), and the base station 13 may provide the user equipment 9 with a plurality of component carriers 2 (labeled as 2b). Additionally, the base station 15 may be connected to a remote radio head (RRH) 151, and the base station 15 itself provides the user equipment 9 with a single component carrier 2 (labeled as 2c) while the RRH 151 provides the user equipment 9 with another component carrier 2 (labeled as 2d). The RRH 151 is only responsible for the transmission and reception of physical layer signals of the component carrier 2 (labeled as 2d), and the component carrier 2 (labeled as 2d) is still mainly managed by the base station 15. Preferably, there is a connection (preferably, a wired connection) of high transmission performance (e.g., having a low latency) between the base station 15 and the RRH 151 thereof to achieve an ideal backhaul connection. The base station 11, the base station 13 and the base station 15 may communicate with each other in an ideal or non-ideal wired or wireless way, or communicate with each other via a backend network 8 with an ideal backhaul connection. The user equipment 9 is located in the coverage of each of the base station 11, the base station 13, the base station 15 and the RRH 151 at the same time, so it can communicate with the base station 11, the base station 13, the base station 15 and the RRH 151 via a plurality of component carriers 2.

Referring to FIG. 2, a base station 10 may comprise a processor 101 and a transceiver 103. The processor 101 and the transceiver 103 may be electrically connected directly or indirectly and communicate with each other. Herein, “directly electrically connected” means that the two components are electrically connected without any other intervening component therebetween, and “indirectly electrically connected” means that the two components are electrically connected with an intervening component therebetween. The base station 10 may be any one of the base station 11, the base station 13 and the base station 15. The transceiver 103 may comprise one or more of various transceivers to communicate with other base stations, the backend network 8 and the user equipment 9. The user equipment 9 may also comprise a transceiver (not shown) to communicate with the base station 10 and other base stations (including the RRH).

The base station 10 may comprise a computer device. The computer device may comprise a computing component such as a general-purpose processor or microprocessor, and execute various computations by use of this computing component. The computer device may comprise a storage component such as a general-purpose memory and/or storage, and store various data in this storage component. The computer device may comprise general-purpose input/output components, and receive incoming data and transmit outgoing data via the input/output components. The computer device may execute corresponding operations via the computing component, the storage component, the input/output components or the like according to processes implemented by software, firmware, programs, algorithms or the like. The processor 101 may be the computer device itself or may be a part of the computer device, and is configured to execute the following operations.

The processor 101 may be configured to create an uplink control information schedule 4 for the uplink control information 6 generated by the user equipment 9. The transceiver 103 may be configured to provide the user equipment 9 with the uplink control information schedule 4 in various ways (e.g., through unicasting, multicasting, broadcasting or the like) so that the user equipment 9 transmits the uplink control information 6 on the plurality of component carriers 2 provided by the CA communication system 1 according to the uplink control information schedule 4. The component carriers 2 provided by the CA communication system 1 may comprise one primary component carrier (i.e., PCC) and at least one secondary component carrier (i.e., SCC1˜SCCn, wherein n is a positive integer greater than 1).

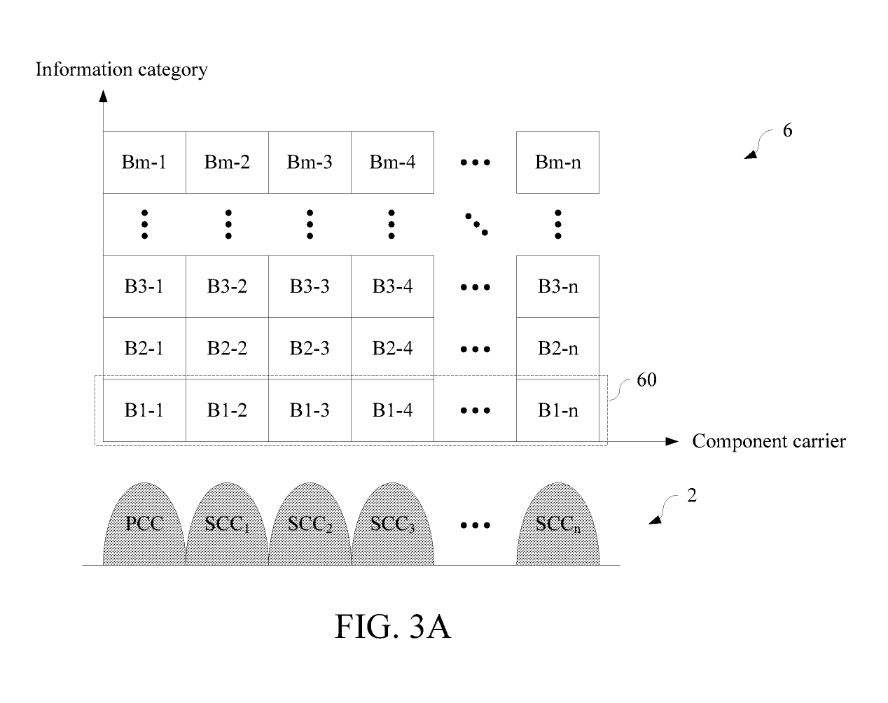

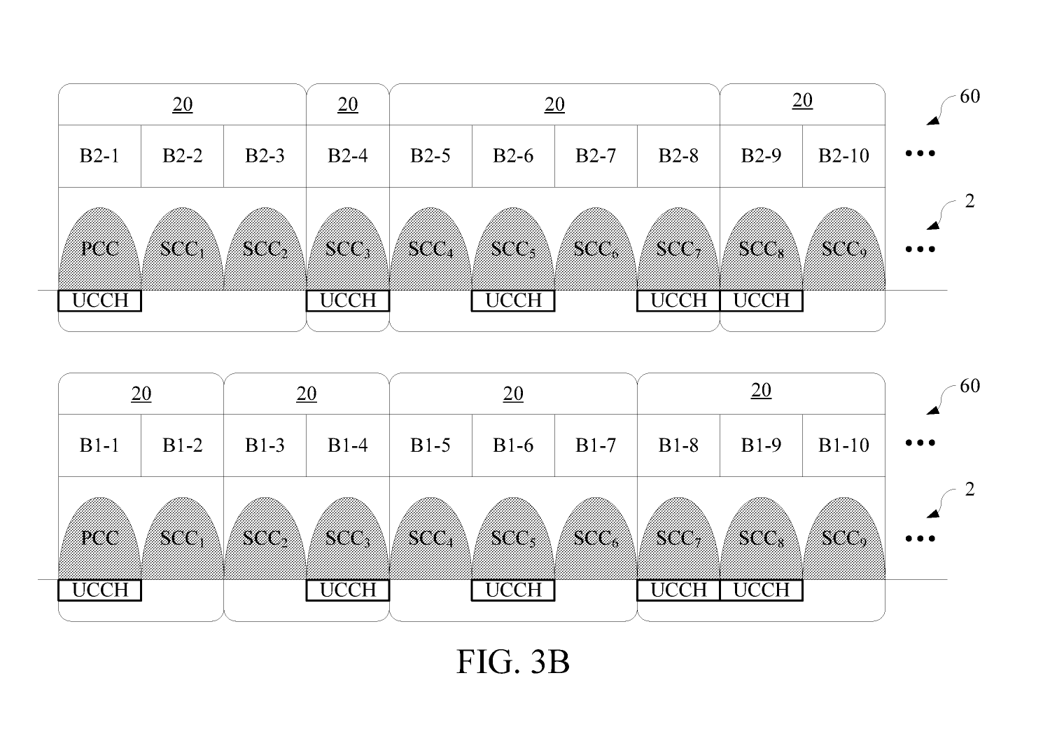

For ease of description, FIG. 3A and FIG. 3B are taken as an example herein to further describe the operation of the processor 101 and the transceiver 103; however, this example is not intended to be limiting. FIG. 3A and FIG. 3B are schematic views illustrating an example of an uplink control information schedule according to one or more embodiments of the present invention. Referring to FIG. 3A, the uplink control information schedule 4 created by the processor 101 may divide the uplink control information 6 generated by the user equipment 9 into a plurality of information blocks 60 according to information categories, and each of the information blocks 60 may comprise a plurality of information sub-blocks Bm-n respectively corresponding to the component carriers 2, wherein m is a positive integer for indicating the corresponding information categories, and n is a positive integer for indicating the corresponding component carriers 2. The information categories may vary in response to different communication systems. Taking the LTE-Advanced proposed by the 3GPP as an example, the uplink control information 6 may include but is not limited to at least one of a Hybrid Automatic Repeat Request (HARQ) Acknowledge (ACK)/Non-Acknowledge (NACK), a Scheduling Request (SR), and Channel State

Information (CSI) or the like.

For example, the first information block 60 corresponds to the first information category comprised in the uplink control information 6, and comprises n information sub-blocks B1-1˜B1-n; the second information block 60 corresponds to the second information category comprised in the uplink control information 6, and comprises n information sub-blocks B2-1˜B2-n; . . .; and the m^{th} information block 60 corresponds to the m^{th} information category comprised in the uplink control information 6, and comprises n information sub-blocks Bm-1˜Bm-n. Therefore, as shown in FIG. 3A, the uplink control information 6 generated by the user equipment 9 may be presented as one two-dimensional matrix.

Referring to FIG. 3A, for each of the information blocks 60, the uplink control information schedule 4 created by the processor 101 may divide the plurality of component carriers 2 (i.e., the PCC and the SCC1˜SCCn) provided by the CA communication system 1 into a plurality of carrier groups 20, each of the carrier groups 20 comprises at least one uplink control channel UCCH, and the information sub-blocks corresponding to each of the carrier groups 20 are scheduled to the at least one uplink control channel UCCH comprised in the carrier group 20. For each of the information blocks 60, the processor 101 can independently determine how to divide the component carriers 2 provided by the CA communication system 1 into a plurality of carrier groups 20. Thus, for different information blocks 60, the uplink control information schedule 4 created by the processor 101 may divide the component carriers 2 provided by the CA communication system 1 into a plurality of carrier groups 20 in the same or different ways.

Ideally, if an uplink control channel UCCH may be created on each of the component carriers 2 (i.e., the PCC and the SCC1˜SCCn) provided by the CA communication system 1, then for each of the information blocks 60, the uplink control information schedule 4 created by the processor 101 may divide each of the component carriers 2 provided by the CA communication system 1 into one group. That is, the number of the carrier groups 20 is the same as the number of the component carriers 2. However, when an uplink control channel UCCH cannot be created on one or more of the component carriers 2 (i.e., the PCC and the SCC1˜SCCn) provided by the CA communication system 1, the uplink control information schedule 4 created by the processor 101 must properly divide the component carriers 2 (i.e., the PCC and the SCC1˜SCCn) provided by the CA communication system 1 into a plurality of carrier groups 20 so that each of the carrier groups 20 comprises at least one uplink control channel UCCH and the information sub-blocks corresponding to the same carrier group 20 are scheduled to one or more uplink control channel UCCH comprised in the carrier group 20.

Taking FIG. 3B as an example, it is assumed that an uplink control channel UCCH can be created respectively on the primary component carrier PCC, and the secondary component carriers SCC3, SCC5, SCC7 and SCC8, and an uplink control channel UCCH cannot be created on any of the secondary component carriers SCC1, SCC2, SCC4, SCC6 and SCC9. In this case, the uplink control information schedule 4 created by the processor 101 may divide the first information block 60 into four carrier groups 20, wherein the first carrier group 20 comprises the primary component carrier PCC and the secondary component carrier SCC1, the second carrier group 20 comprises the secondary component carriers SCC2 and SCC3, the third carrier group 20 comprises the secondary component carriers SCC4, SCC5 and SCC6, and the fourth carrier group 20 comprises the secondary component carriers SCC7, SCC8 and SCC9. The information sub-blocks B1-1 and B1-2 respectively corresponding to the primary component carrier PCC and the secondary component carrier SCC1 will be transmitted through the uplink control channel UCCH created on the primary component carrier PCC, the information sub-blocks B1-3 and B1-4 respectively corresponding to the secondary component carriers SCC2 and SCC3 will be transmitted through the uplink control channel UCCH created on the secondary component carrier SCC3, the information sub-blocks B1-5, B1-6 and B1-7 respectively corresponding to the secondary component carriers SCC4, SCC5 and SCC6 will be transmitted through the uplink control channel UCCH created on the secondary component carrier SCC5, and the information sub-blocks B1-8, B1-9 and B1-10 respectively corresponding to the secondary component carriers SCC7, SCC8 and SCC9 will be transmitted through the uplink control channel UCCH created on the secondary component carrier SCC7 and/or the uplink control channel UCCH created on the secondary component carrier SCC8. For the information sub-blocks B1-8, B1-9 and B1-10, the processor 101 may provide the user equipment 9 with instructions for selection of the uplink control channels UCCH created on the secondary component carriers SCC7 and SCC8 when the processor 101 creates or updates the uplink control information schedule 4.

Taking FIG. 3B as an example again, the uplink control information schedule 4 created by the processor 101 may divide the second information block 60 into four carrier groups 20, wherein the first carrier group 20 comprises the primary component carrier PCC and the secondary component carriers SCC1 and SCC2, the second carrier group 20 comprises the secondary component carrier SCC3, the third carrier group 20 comprises the secondary component carriers SCC4, SCC5, SCC6 and SCC7, and the fourth carrier group 20 comprises the secondary component carriers SCC8 and SCC9. The information sub-blocks B2-1, B2-2 and B2-3 corresponding to the primary component carrier PCC and the secondary component carriers SCC1 and SCC2 will be transmitted through the uplink control channel UCCH created on the primary component carrier PCC, the information sub-block B2-4 corresponding to the secondary component carrier SCC3 will be transmitted through the uplink control channel UCCH created on the secondary component carrier SCC3, the information sub-blocks B2-5, B2-6, B2-7 and B2-8 corresponding to the secondary component carriers SCC4, SCC5, SCC6 and SCC7 will be transmitted through the uplink control channel UCCH created on the secondary component carrier SCC5 and/or the uplink control channel UCCH created on the secondary component carrier SCC7, and the information sub-blocks B2-9 and B2-10 corresponding to the secondary component carriers SCC8 and SCC9 will be transmitted through the uplink control channel UCCH created on the secondary component carrier SCC8. For the information sub-blocks B2-5, B2-6, B2-7 and B2-8, the processor 101 may provide the user equipment 9 with instructions for selection of the uplink control channels UCCH created on the secondary component carriers SCC5 and SCC7 when the processor 101 creates or updates the uplink control information schedule 4.

The processor 101 may create the uplink control information schedule 4 according to various factors. For example, the processor 101 may create the uplink control information schedule 4 according to at least one of the following factors: priorities (not shown) of the information categories comprised in the uplink control information 6, a data size (not shown) of the uplink control information 6, resource status information 70 of the component carriers 2 provided by the CA communication system 1, feedback path delay information 72, channel status 74 of the component carriers 2 provided by the CA communication system 1, and uplink control information 76 dropped by the user equipment 9 or the like. Additionally, the processor 101 may dynamically adjust the uplink control information schedule 4 in response to changes of the factors.

For example, the processor 101 may be configured to determine the priorities of the information categories comprised in the uplink control information 6 and the data size of the uplink control information 6. When the processor 101 is creating the uplink control information schedule 4, the processor 101 may consider grouping more component carriers 2 into a carrier group 20 for the information category of a low priority, and may consider grouping fewer component carriers 2 into a carrier group 20 for the information category of a high priority. Furthermore, When the processor 101 is creating the uplink control information schedule 4, the processor 101 may consider grouping more component carriers 2 into a carrier group 20 for the uplink control information 6 of a small data size, and may consider grouping fewer component carriers 2 into a carrier group 20 for the uplink control information 6 of a large data size.

As another example, the transceiver 103 may be configured to exchange the resource status information 70 and the feedback path delay information 74 corresponding to the component carriers 2 with at least one other base station in the CA communication system 1. Taking FIG. 1 as an example, each of the base station 11, the base station 13 and the base station 15 may evaluate the resource of the component carrier 2 provided by it (including the resource required by creating the uplink channel UCCH), and the resource status information 70 is exchanged between these base stations. When the processor 101 is creating the uplink control information schedule 4, the processor 101 may consider grouping the component carrier 2 that has less resource and fewer other component carriers 2 into a carrier group 20, and may consider grouping the component carrier 2 that has more resource and more other component carriers 2 into a carrier group 20.

Additionally, as described above, if an uplink control channel UCCH cannot be created over one or more of the component carriers 2 (i.e., the PCC and the SCC1˜SCCn) provided by the CA communication system 1, then the information sub-block corresponding to a certain component carrier 2 will instead be transmitted in the uplink control channel UCCH created on another component carrier 2 or other component carriers 2 within the same group, and the source of the another component carrier 2 will transmit the information sub-block back to the source of the component carrier 2 after receiving the information sub-block. At this point, the time period during which the information sub-block is transmitted back to the source of the component carrier 2 is the feedback path delay. Taking FIG. 1 as an example, the feedback path delay information 72 may be shared between the base station 11, the base station 13 and the base station 15. When the processor 101 is creating the uplink control information schedule 4, the processor 101 may consider grouping the component carrier 2 provided by the source of a low feedback path delay (which may be a base station or an RRH) and more other component carriers 2 into a carrier group 20, and may consider grouping the component carrier 2 provided by the source of a high feedback path delay (which may be a base station or an RRH) and fewer other component carriers 2 into a carrier group 20.

As another example, the transceiver 103 may be further configured to receive the channel status 74 of the component carriers 2 and the uplink control information 76 dropped by the user equipment 9 from the user equipment 9. The channel status 74 of each of the component carriers 2 may include but is not limited to: at least one of a Channel Quality Indicator (CQI) and a Sounding Reference Signal (SRS) or the like. The user equipment 9 may measure the channel status 74 of the component carriers 2 provided by the CA communication system 1 and transmit the channel status 74 to the transceiver 103. Preferably, the uplink control information 6 may comprise the channel status 74, and the transceiver 103 may receive the channel status 74 by receiving the uplink control information 6. When the processor 101 is creating the uplink control information schedule 4, the processor 101 may consider grouping the component carrier 2 of a poor channel status and fewer other component carriers 2 into a carrier group 20, and may consider grouping the component carrier 2 of a good channel status and more other component carriers 2 into a carrier group 20. Additionally, when the processor 101 is creating or updating the uplink control information schedule 4, the processor 101 may select to create the uplink control channel UCCH on the component carrier 2 of a relatively good channel status. As described above, in cases where the same carrier group 20 comprises more than one uplink control channel UCCH created on the component carriers 2, the processor 101 may further comprise instructions for selection of the uplink control channels UCCH by the user equipment 9 when the processor 101 is creating or updating the uplink control information schedule 4.

Moreover, in some cases (e.g., where the communication environment is poor), the user equipment 9 may give up transmitting some information sub-block(s) (or even give up transmitting one or more information blocks 60) to the transceiver 103, and inform the base station 10 which information sub-block(s) is (are) dropped by the user equipment 9 by transmitting the uplink control information 76 dropped by the user equipment 9 to the transceiver 103. When the processor 101 is creating the uplink control information schedule 4, the processor 101 may consider grouping the component carrier 2 corresponding to the information sub-block dropped by the user equipment 9 and fewer other component carriers 2 into a carrier group 20.

In an example of this embodiment, after obtaining the uplink control information schedule 4 provided by the transceiver 103, the user equipment 9 may first store the uplink control information schedule 4 and still transmit the uplink control information 6 to the transceiver 103 in the original way (e.g., transmit the uplink control information 6 corresponding to the component carriers 2 only through the uplink channel UCCH created on the primary component carrier PCC). In this case, the transceiver 103 may be configured to transmit an instruction signal 5 to the user equipment 9, and the user equipment 9 will only transmit the uplink control information 6 on the component carriers 2 provided by the CA communication system 1 according to the uplink control information schedule 4 after receiving the instruction signal 5. For example, when the processor 101 determines that a certain component carrier 2 (e.g., the primary component carrier PCC) is unable to bear the load of the uplink control information 6 generated by the user equipment 9, the transceiver 103 may transmit the instruction signal 5 to the user equipment 9 so that the user equipment 9 transmits the uplink control information 6 on the component carriers 2 according to the uplink control information schedule 4 in response to the instruction signal 5.

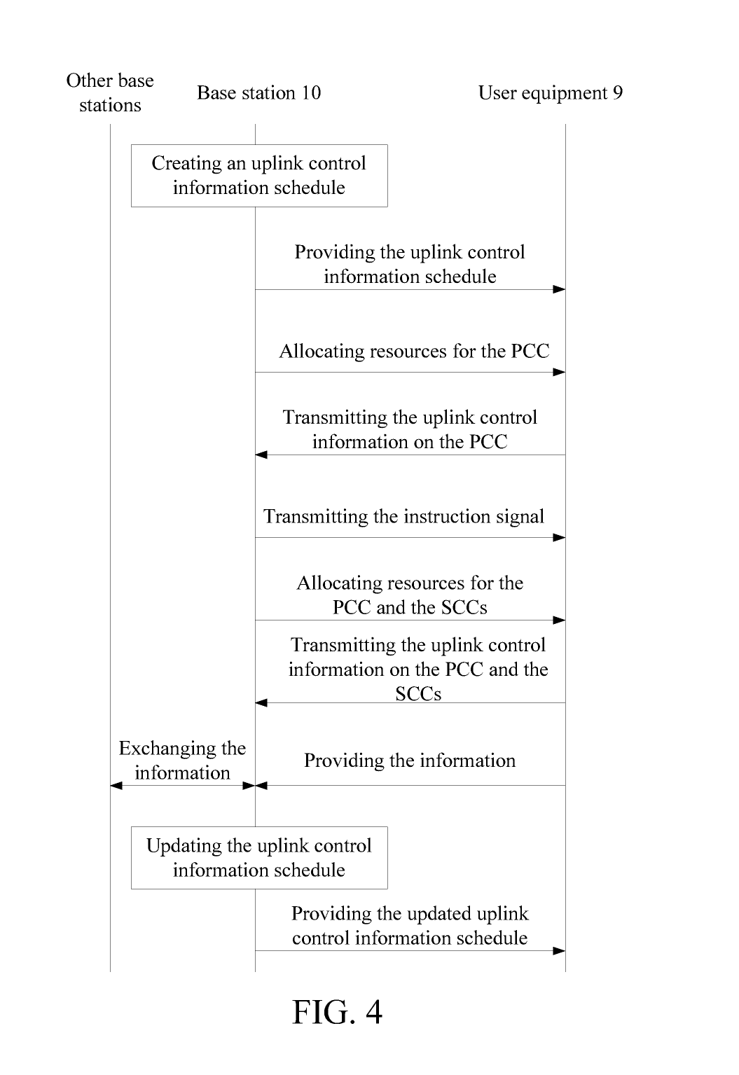

FIG. 4 is taken as an example herein to further describe an overall operation of the CA communication system 1; however, this example is not intended to be limiting. FIG. 4 is a schematic view illustrating an example of an overall operation of the carrier aggregation communication system 1 shown in FIG. 1 according to one or more embodiments of the present invention. Referring to FIG. 4, the base station 10 may create an uplink control information schedule 4 for the uplink control information 6 generated by the user equipment 9. Then, the base station 10 may provide the user equipment 9 with the uplink control information schedule 4. Next, the base station 10 may allocate resources for the primary component carrier PCC, and the user equipment 9 may use the resources of the primary component carrier PCC to transmit the uplink control information 6 on the primary component carrier PCC. In this case, like the traditional CA communication system, the user equipment 9 transmits the uplink control information 6 only in the uplink control channel UCCH created on the primary component carrier PCC (which may be regarded as the mode 1).

When the base station 10 determines that a certain component carrier 2 (e.g., the primary component carrier PCC) is unable to bear the load of the uplink control information 6 generated by the user equipment 9 (or for other reasons, e.g., in response to a load-sharing demand), the base station 10 may transmit the instruction signal 5 to the user equipment 9. Thereafter, the base station 10 may allocate resources for the primary component carrier PCC and the secondary component carriers SCC1˜SCCn, and the user equipment 9 may use the resources of the primary component carrier PCC and the secondary component carriers SCC1˜SCCn according to the uplink control information schedule 4 so as to transmit the uplink control information 6 on the primary component carrier PCC and the secondary component carriers SCC1˜SCCn (which may be regarded as the mode 2).

The user equipment 9 may continuously provide information to the base station 10 (e.g., information such as the channel status 74 of the component carriers 2, and uplink control information 76 dropped by the user equipment 9 or the like), and the base station 10 may continuously exchange information with other base stations (e.g., the information is the resource status information 70 and the feedback path delay information 72 corresponding to the component carriers 2, or the like). Thereafter, the base station 10 may dynamically update the uplink control information schedule 4 according to the information from other base stations and the user equipment 9, and provide the updated uplink control information schedule 4 to the user equipment 9.

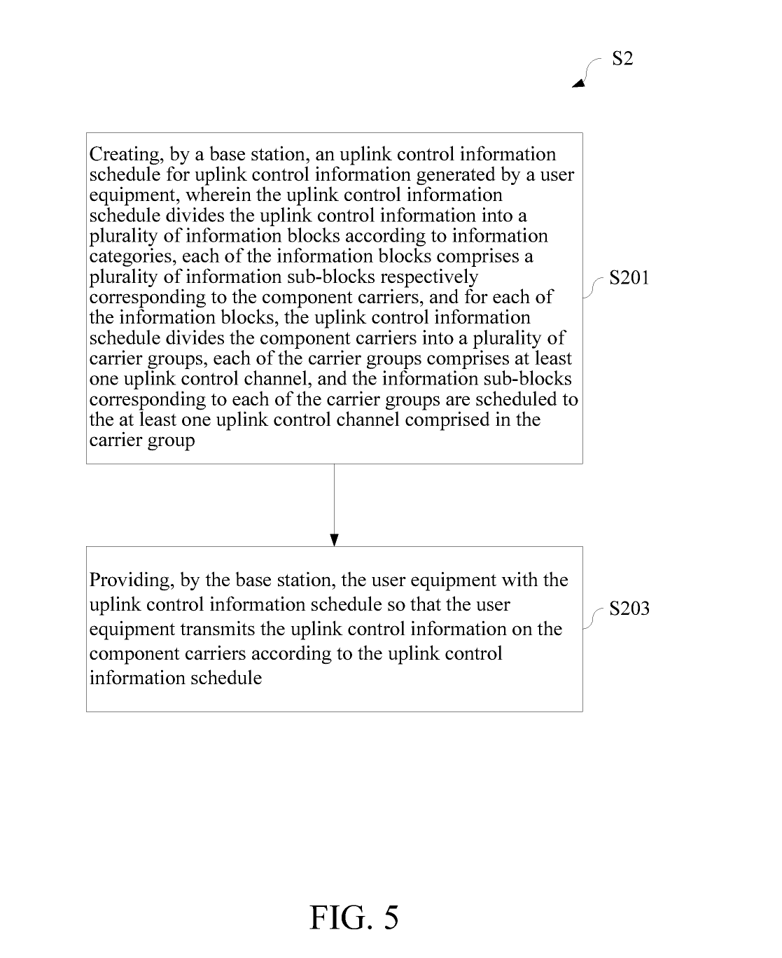

Another embodiment of the present invention (which is called a “second embodiment” hereinafter) is an uplink control information scheduling method for a carrier aggregation communication system. FIG. 5 is taken as an example herein to describe the uplink control information scheduling method; however, this example is not intended to be limiting. FIG. 5 is a flowchart diagram illustrating an example of an uplink control information schedule method for a carrier aggregation communication system according to one or more embodiments of the present invention. It shall be appreciated that the order of the steps mentioned in the second embodiment and various examples thereof may be adjusted arbitrarily without departing from the spirit of the present invention and such order should not be regarded as a limitation.

As shown in FIG. 5, the uplink control information scheduling method S2 may comprise the following steps of: creating, by a base station, an uplink control information schedule for uplink control information generated by a user equipment, wherein the uplink control information schedule divides the uplink control information into a plurality of information blocks according to information categories, each of the information blocks comprises a plurality of information sub-blocks respectively corresponding to the component carriers, and for each of the information blocks, the uplink control information schedule divides the component carriers into a plurality of carrier groups, each of the carrier groups comprises at least one uplink control channel, and the information sub-blocks corresponding to each of the carrier groups are scheduled to the at least one uplink control channel comprised in the carrier group (i.e., step S201); and providing, by the base station, the user equipment with the uplink control information schedule so that the user equipment transmits the uplink control information on the component carriers according to the uplink control information schedule (i.e., step S203). The uplink control information scheduling method S2 of this embodiment may be used in the CA communication system 1 of the first embodiment, so the base station and the user equipment described in this embodiment and the examples thereof may respectively correspond to the base station 10 and the user equipment 9.

As an example of the second embodiment, the uplink control information scheduling method S2 may further comprise the following step of: transmitting, by the base station, an instruction signal to the user equipment so that the user equipment transmits the uplink control information on the component carriers according to the uplink control information schedule in response to the instruction signal.

As an example of the second embodiment, the component carriers include a primary component carrier and at least one secondary component carrier, and the uplink control information scheduling method S2 further comprises the following steps of: determining, by the base station, whether the primary component carrier is able to bear the load of the uplink control information generated by the user equipment, and when it is determined that the primary component carrier is unable to bear the load of the uplink control information generated by the user equipment, transmitting the instruction signal to the user equipment by the base station.

As an example of the second embodiment, the base station creates the uplink control information schedule according to at least one of the following factors: priorities of the information categories, a data size of the uplink control information, feedback path delay information, resource status information of the component carriers, channel status of the component carriers, and uplink control information dropped by the user equipment. In this example, optionally, the channel status of each of the component carriers may comprise at least one of a Channel Quality Indicator (CQI) and a Sounding Reference Signal (SRS). In this example, optionally, the uplink control information scheduling method S2 may further comprise the following step of: dynamically adjusting, by the base station, the uplink control information schedule in response to changes of the factors. In this example, optionally, the uplink control information scheduling method S2 may further comprise the following step of: receiving, by the base station, the channel status of the component carriers and the uplink control information dropped by the user equipment from the user equipment. In this example, optionally, the carrier aggregation system may further comprise at least one other base station, and the uplink control information scheduling method S2 may further comprise the following step of: exchanging, by the base station, the resource status information and the feedback path delay information corresponding to the component carriers with the at least one other base station. In this example, optionally, the uplink control information scheduling method S2 may further comprise the following step of: determining, by the base station, the priorities of the information categories and the data size of the uplink control information.

As an example of the second embodiment, in the uplink control information scheduling method S2, the uplink control information may include but is not limited to at least one of a Hybrid Automatic Repeat Request (HARQ) Acknowledge (ACK)/Non-Acknowledge (NACK), a Scheduling Request (SR), and Channel State Information (CSI).

The uplink control information scheduling method S2 substantially comprises steps corresponding to all operations of the CA communication system 1. The corresponding steps comprised in the uplink control information scheduling method S2 shall be readily appreciated by those of ordinary skill in the art according to the above description of the CA communication system 1, and thus the details of the corresponding steps will not be further described herein.

In the present invention, via the uplink control information schedule created by a base station, a user equipment can transmit the uplink control information in the plurality of uplink control channels created on the plurality of component carriers instead of only being capable of transmitting the uplink control information in a single uplink control channel created on a single component carrier (e.g., the aforesaid PCC). In this way, the load of the control channel created on the PCC can be distributed to control channels created on other component carriers according to the uplink control information schedule, so the load of the control channel created on the PCC is effectively reduced.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station for a carrier aggregation communication system, the carrier aggregation communication system providing a user equipment with a plurality of component carriers, the base station comprising:
a processor, being configured to create an uplink control information schedule for uplink control information generated by the user equipment; and
a transceiver connected with the processor, being configured to provide the user equipment with the uplink control information schedule so that the user equipment transmits the uplink control information on the component carriers according to the uplink control information schedule;
wherein the uplink control information schedule divides the uplink control information into a plurality of information blocks according to information categories, each of the information blocks comprises a plurality of information sub-blocks respectively corresponding to the component carriers, and for each of the information blocks, the uplink control information schedule divides the component carriers into a plurality of carrier groups, each of the carrier groups comprises at least one uplink control channel, and the information sub-blocks corresponding to each of the carrier groups are scheduled to the at least one uplink control channel comprised in the carrier group.

2. The base station of claim 1, wherein the transceiver is further configured to transmit an instruction signal to the user equipment so that the user equipment transmits the uplink control information on the component carriers according to the uplink control information schedule in response to the instruction signal.

3. The base station of claim 2, wherein the component carriers include a primary component carrier and at least one secondary component carrier, and when the processor determines that the primary component carrier is unable to bear the load of the uplink control information generated by the user equipment, the transceiver transmits the instruction signal to the user equipment.

4. The base station of claim 1, wherein the processor creates the uplink control information schedule according to at least one of the following factors: priorities of the information categories, a data size of the uplink control information, feedback path delay information, resource status information of the component carriers, channel status of the component carriers, and uplink control information dropped by the user equipment.

5. The base station of claim 4, wherein the channel status of each of the component carriers comprises at least one of a Channel Quality Indicator (CQI) and a Sounding Reference Signal (SRS).

6. The base station of claim 4, wherein the processor further dynamically adjusts the uplink control information schedule in response to changes of the factors.

7. The base station of claim 4, wherein the transceiver is further configured to receive the channel status of the component carriers and the uplink control information dropped by the user equipment from the user equipment.

8. The base station of claim 4, wherein the carrier aggregation communication system further comprises at least one other base station, and the transceiver is further configured to exchange the resource status information and the feedback path delay information corresponding to the component carriers with the at least one other base station.

9. The base station of claim 4, wherein the processor is further configured to determine the priorities of the information categories and the data size of the uplink control information.

10. The base station of claim 1, wherein the uplink control information comprises at least one of a Hybrid Automatic Repeat Request (HARQ) Acknowledge (ACK)/Non-Acknowledge (NACK), a Scheduling Request (SR), and Channel State Information (CSI).

11. An uplink control information scheduling method for a carrier aggregation communication system, the carrier aggregation communication system providing a user equipment with a plurality of component carriers, the uplink control information scheduling method comprising:
creating, by a base station, an uplink control information schedule for uplink control information generated by the user equipment, wherein the uplink control information schedule divides the uplink control information into a plurality of information blocks according to information categories, each of the information blocks comprises a plurality of information sub-blocks respectively corresponding to the component carriers, and for each of the information blocks, the uplink control information schedule divides the component carriers into a plurality of carrier groups, each of the carrier groups comprises at least one uplink control channel, and the information sub-blocks corresponding to each of the carrier groups are scheduled to the at least one uplink control channel comprised in the carrier group; and
providing, by the base station, the user equipment with the uplink control information schedule so that the user equipment transmits the uplink control information on the component carriers according to the uplink control information schedule.

12. The uplink control information scheduling method of claim 11, further comprising transmitting, by the base station, an instruction signal to the user equipment so that the user equipment transmits the uplink control information on the component carriers according to the uplink control information schedule in response to the instruction signal.

13. The uplink control information scheduling method of claim 12, wherein the component carriers include a primary component carrier and at least one secondary component carrier, and the uplink control information scheduling method further comprises determining, by the base station, whether the primary component carrier is able to bear the load of the uplink control information generated by the user equipment, and when it is determined that the primary component carrier is unable to bear the load of the uplink control information generated by the user equipment, transmitting the instruction signal to the user equipment by the base station.

14. The uplink control information scheduling method of claim 11, wherein the base station creates the uplink control information schedule according to at least one of the following factors: priorities of the information categories, a data size of the uplink control information, feedback path delay information, resource status information of the component carriers, channel status of the component carriers, and uplink control information dropped by the user equipment.

15. The uplink control information scheduling method of claim 14, wherein the channel status of each of the component carriers comprises at least one of a Channel Quality Indicator (CQI) and a Sounding Reference Signal (SRS).

16. The uplink control information scheduling method of claim 14, further comprising the following step of: dynamically adjusting, by the base station, the uplink control information schedule in response to changes of the factors.

17. The uplink control information scheduling method of claim 14, further comprising receiving, by the base station, the channel status of the component carriers and the uplink control information dropped by the user equipment from the user equipment.

18. The uplink control information scheduling method of claim 14, wherein the carrier aggregation communication system further comprises at least one other base station, and the uplink control information scheduling method further comprises exchanging, by the base station, the resource status information and the feedback path delay information corresponding to the component carriers with the at least one other base station.

19. The uplink control information scheduling method of claim 14, further comprising determining , by the base station, the priorities of the information categories and the data size of the uplink control information.

20. The uplink control information scheduling method of claim 11, wherein the uplink control information comprises at least one of a Hybrid Automatic Repeat Request (HARQ) Acknowledge (ACK)/Non-Acknowledge (NACK), a Scheduling Request (SR), and Channel State Information (CSI).
